(19) United States
(12) Patent Application Publication
(10) Pub. No.: US 2009/0300334 A1
(43) Pub. Date: Dec. 3, 2009

(54) Method and Apparatus for Loading Data and Instructions Into a Computer

(75) Inventors: Dean Sanderson, Camarillo, CA (US); Charles H. Moore, Sierra City, CA (US); Randy Leberknight, San Jose, CA (US); Michael B. Montvelishsky, Burlingame, CA (US); Jeffrey A. Fox, Berkeley, CA (US)

Correspondence Address: HENNEMAN & ASSOCIATES, PLC, 70 N. MAIN ST., THREE RIVERS, MI, 49093, US

(73) Assignee: VNS PORTFOLIO LLC, Cupertino, CA (US)

(21) Appl. No.: 12/134,018

(22) Filed: Jun. 5, 2008

Related U.S. Application Data
(60) Provisional application No. 61/057,202, filed on May 30, 2008.

(51) Int. Cl. G06F 9/30

(52) U.S. Cl. 712/220; 712/E09.016

(57) ABSTRACT

A computer array (10) has a plurality of computers (12). The computers (12) communicate with each other asynchronously, and the computers (12) themselves operate in a generally asynchronous manner internally. When one computer (12) attempts to communicate with another it goes to sleep until the other computer (12) is ready to complete the transaction, thereby saving power and reducing heat production. The sleeping computer (12) can be awaiting data or instructions (12). In the case of instructions, the sleeping computer (12) can be waiting to store the instructions or to immediately execute the instructions. In the later case, the instructions are placed in an instruction register (30a) when they are received and executed therefrom, without first placing the instructions first into memory. The instructions can include a stream loader (100) which is capable of sending a stream of compiled object code to multiple computers of a multicore processor along a predefined path (84) by using execution of instructions directly from the communication ports of the computers.

### RELATED APPLICATIONS

This application claims the benefit of provisional U.S. Patent Application Ser. No. 61/057,202 filed May 30, 2008 entitled SEAforth® VentureForth® Documents and Code, which is incorporated herein by reference in its entirety.

### BACKGROUND OF THE INVENTION

1. Field of the Invention

The present invention relates to the field of computers and computer processors, and more particularly to a method and means for allowing a computer to execute instructions as they are received from an external source without first storing said instruction, and an associated method for using that method and means to facilitate communications between computers and the ability of a computer to use the available resources of another computer. The predominant current usage of the present invention direct execution method and apparatus is in the combination of multiple computers on a single microchip, wherein operating efficiency is important not only because of the desire for increased operating speed but also because of the power savings and heat reduction that are a consequence of the greater efficiency.

2. Description of the Background Art

In the art of computing, processing speed is a much desired quality, and the quest to create faster computers and processors is ongoing. However, it is generally acknowledged in the industry that the limits for increasing the speed in microprocessors are rapidly being approached, at least using presently known technology. Therefore, there is an increasing interest in the use of multiple processors to increase overall computer speed by sharing computer tasks among the processors.

The use of multiple processors tends to create a need for communication between the processors. Indeed, there may well be a great deal of communication between the processors, such that a significant portion of time is spent in transferring instructions and data there between. Where the amount of such communication is significant, each additional instruction that must be executed in order to accomplish it places an incremental delay in the process which, cumulatively, can be very significant. The conventional method for communicating instructions or data from one computer to another involves first storing the data or instruction in the receiving computer and then, subsequently, calling it for execution (in the case of an instruction) or for operation thereon (in the case of data).

It would be useful to reduce the number of steps required to transmit, receive, and then use information, in the form of data or instructions, between computers. However, to the inventor's knowledge no prior art system has streamlined the above described process in a significant manner.

Also, in the prior art it is known that it is necessary to “get the attention” of a computer from time to time. That is, sometimes even though a computer may be busy with one task, another time sensitive task requirement can occur that may necessitate temporarily diverting the computer away from the first task. Examples include, but are not limited to, instances where a user input device is used to provide input to the computer. In such cases, the computer might need to temporarily acknowledge the input and/or react in accordance with the input. Then, the computer will either continue what it was doing before the input or else change what it was doing based upon the input. Although an external input is used as an example here, the same situation occurs when there is a potential conflict for attention between internal aspects of the computer, as well.

When receiving data and change in status from I/O ports there have been two methods available in the prior art. One has been to “poll” the port, which involves reading the status of the port at regular intervals to determine whether any data has been received or a change of status has occurred. However, polling the port consumes considerable time and resources which could usually be better used doing other things. A better alternative has often been the use of “interrupts”. When using interrupts, a processor can go about performing its assigned task and then, when a I/O Port/Device needs attention as indicated by the fact that a byte has been received or status has changed, it sends an Interrupt Request (IRQ) to the processor. Once the processor receives an Interrupt Request, it finishes its current instruction, places a few things on the stack, and executes the appropriate Interrupt Service Routine (ISR) which can remove the byte from the port and place it in a buffer. Once the ISR has finished, the processor returns to where it left off. Using this method, the processor doesn't have to waste time, looking to see if the I/O Device is in need of attention, but rather the device will only service the interrupt when it needs attention. However, the use of interrupts, itself, is far less than desirable in many cases, since there can be a great deal of overhead associated with the use of interrupts. For example, each time an interrupt occurs, a computer may have to temporarily store certain data relating to the task it was previously trying to accomplish, then load data pertaining to the interrupt, and then reload the data necessary for the prior task once the interrupt is handled. Interrupts disturb time-sensitive processing. Essentially they make timing unpredictable. Obviously, it would be desirable to reduce or eliminate all of this time and resource consuming overhead. However, no prior art method has been developed which has alleviated the need for interrupts.

Conventional parallel computing usually ties a number of computers to a common data path or bus. In such an arrangement individual computers are each assigned an address. In a Beowulf cluster for example individual PC's are connected to an Ethernet by TCP/IP protocol and given an address or URL. When data or instructions are conveyed to an individual computer they are placed in a packet addressed to that computer.

Direct connection of a plurality of computers, for example by separate, single-drop buses to adjacent, neighboring computers, without a common bus over which to address the computers individually, and asynchronous operation, rather than synchronously clocked operation of a computer system, are also known in the art, as described, for example in Moore et al. (U.S. Pat. App. Pub. No. 2007/0250682 A1). Asynchronous circuits can have a speed advantage, as sequential events can proceed at their actual pace rather than in a predetermined number of clock cycles; further, asynchronous circuits can require fewer transistors to implement, and need less operating power, as only the active circuits are operating at a given moment; and still further, distribution of a single clock is not required, thus saving layout area on a microchip, which can be advantageous in single-chip and embedded system applications. A related problem is how to efficiently transfer data and instructions to individual computers in such a computer. This problem is more difficult due to the architecture of this type of computer not including separately addressable computers.

### SUMMARY

Briefly, an embodiment of the present invention is a computer having its own memory such that it is capable of independent computational functions. In one embodiment of the invention a plurality of the computers, also known as nodes, cores, or processors, are arranged in an array. In another embodiment each of the computers of the array is directly connected to adjacent, neighboring computers, without a common bus over which to address the computers directly. In yet another embodiment, the array is disposed on a single microchip. In order to accomplish tasks cooperatively, the computers must pass data and/or instructions from one to another. Since all of the computers working simultaneously will typically provide much more computational power than is required by most tasks, and since whatever algorithm or method that is used to distribute the task among the several computers will almost certainly result in an uneven distribution of assignments, it is anticipated that at least some, and perhaps most, of the computers may not be actively participating in the accomplishment of the task at any given time. Therefore, it would be desirable to find a way for under-used computers to be available to assist their busier neighbors by “lending” either computational resources, memory, or both. In order that such a relationship be efficient and useful it would further be desirable that communications and interaction between neighboring computers be as quick and efficient as possible. Therefore, the present invention provides a means and method for a computer to execute instructions and/or act on data provided directly from another computer, rather than having to receive and then store the data and/or instructions prior to such action. It will be noted that this invention will also be useful for instructions that will act as an intermediary to cause a computer to “pass on” instructions or data from one other computer to yet another computer.

Still yet another aspect of the desired embodiment is that, data and instructions can be efficiently loaded and executed into individual computers and/or transferred between such computers. This can be accomplished without recourse to a common bus even when each computer is only directly connected to a limited number of neighbors.

The invention includes a stream loader process, sometimes also referred to as a port loader, for loading programs using port execution. This process can be used to send a stream of compiled object code to various nodes of a multicore processor by using the processor's port execution facility. The stream will enter through an I/O node, and then be sent through ports to other nodes. By use of this facility, programs can be sent to the RAM of any node or combination of nodes, and also the stacks and registers of nodes can be initialized so that the programs sent to the RAM do not have to contain initialization code. By suitable manipulation of instructions the stream may be sent to multiple nodes simultaneously, allowing branching and other complex stream shapes.

These and other objects and advantages of the present invention will become clear to those skilled in the art in view of the description of modes of carrying out the invention, and the industrial applicability thereof, as described herein and as illustrated in the several figures of the drawing. The objects and advantages listed are not an exhaustive list of all possible advantages of the invention. Moreover, it will be possible to practice the invention even where one or more of the intended objects and/or advantages might be absent or not required in the application.

Further, those skilled in the art will recognize that various embodiments of the present invention may achieve one or more, but not necessarily all, of the described objects and/or advantages. Accordingly, the objects and/or advantages described herein are not essential elements of the present invention, and should not be construed as limitations.

### BRIEF DESCRIPTION OF THE DRAWINGS

FIG. 1 is a diagrammatic view of a computer array, according to the present invention;

FIG. 2 is a detailed diagram showing a subset of the computers of FIG. 1 and a more detailed view of the interconnecting data buses of FIG. 1;

FIG. 3 is a block diagram depicting a general layout of one of the computers of FIGS. 1 and 2;

FIG. 4 is a symbolic diagram of elements of a stream according to an embodiment of the invention;

FIG. 5a is a printout of the source code for a Domino portion of an embodiment of the stream loader, according to the invention;

FIG. 5b is a printout of the source code for a second portion of an embodiment of the stream loader, according to the invention;

FIG. 5c is a symbolic block diagram depicting the order of the source code portions shown in FIGS. 5a and 5b.

### DETAILED DESCRIPTION OF THE INVENTION

This invention is described in the following description with reference to the Figures, in which like numbers represent the same or similar elements. While this invention is described in terms of modes for achieving this invention's objectives, it will be appreciated by those skilled in the art that variations may be accomplished in view of these teachings without deviating from the spirit or scope of the present invention.

The embodiments and variations of the invention described herein, and/or shown in the drawings, are presented by way of example only and are not limiting as to the scope of the invention. Unless otherwise specifically stated, individual aspects and components of the invention may be omitted or modified, or may have substituted therefore known equivalents, or as yet unknown substitutes such as may be developed in the future or such as may be found to be acceptable substitutes in the future. The invention may also be modified for a variety of applications while remaining within the spirit and scope of the claimed invention, since the range of potential applications is great, and since it is intended that the present invention be adaptable to many such variations. While the invention is describe using a variation of the FORTH programming language called Machine Forth it is well within the ambit of the invention to use any suitable language.

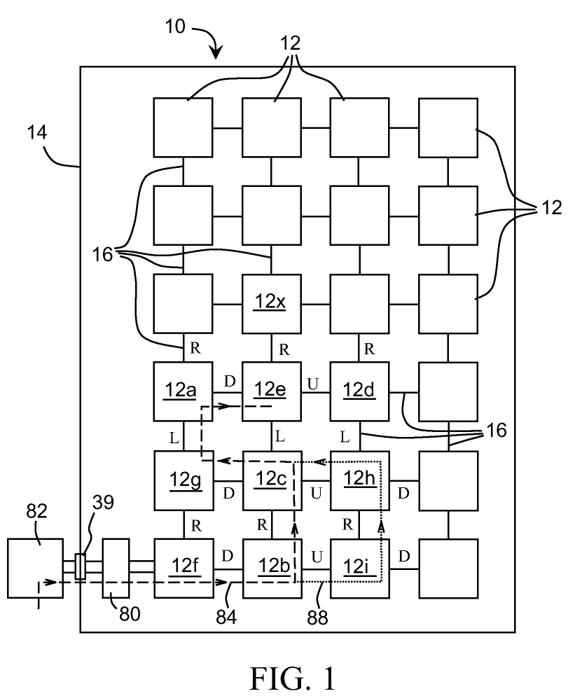

A mode for carrying out the invention is an array of individual computers. The array is depicted in a diagrammatic view in FIG. 1 and is designated therein by the general reference character 10. According to an embodiment of the invention, a single-chip SEAforth™-24A array processor can serve as array 10. The computer array 10 has a plurality (twenty four in the example shown) of computers 12 (sometimes also referred to as “cores” or “nodes” in the example of an array). In the example shown, all of the computers 12 are located on a single die 14. According to the present invention, each of the computers 12 is a generally independently functioning computer, as will be discussed in more detail hereinafter. The computers 12 are interconnected by a plurality (the quantities of which will be discussed in more detail hereinafter) of interconnecting data buses 16. In this example, the data buses 16 are bidirectional, asynchronous, high-speed, parallel data buses, although it is within the scope of the invention that other interconnecting means might be employed for the purpose. In the present embodiment of the array 10, not only is data communication between the computers 12 asynchronous, the individual computers 12 also operate in an internally asynchronous mode. This has been found by the inventor to provide important advantages. For example, since a clock signal does not have to be distributed throughout the computer array 10, a great deal of power is saved. Furthermore, not having to distribute a clock signal eliminates many timing problems that could limit the size of the array 10 or cause other known difficulties. Also, the fact that the individual computers operate asynchronously saves a great deal of power, since each computer will use essentially no power when it is not executing instructions, since there is no clock running therein.

One skilled in the art will recognize that there will be additional components on the die 14 that are omitted from the view of FIG. 1 for the sake of clarity. Such additional components include power buses, external connection pads, and other such common aspects of a microprocessor chip.

Computer 12e is an example of one of the computers 12 that is not on the periphery of the array 10. That is, computer 12e has four orthogonally adjacent computers 12a, 12x, 12c and 12d. This grouping of computers 12a through 12e will be used, by way of example, hereinafter in relation to a more detailed discussion of the communications between the computers 12 of the array 10. As can be seen in the view of FIG. 1, interior computers such as computer 12e will have four other computers 12 with which they can directly communicate via the buses 16. In the following discussion, the principles discussed will apply to all of the computers 12 except that the computers 12 on the periphery of the array 10 will be in direct communication with only three or, in the case of corner computers 12, only two other of the computers 12.

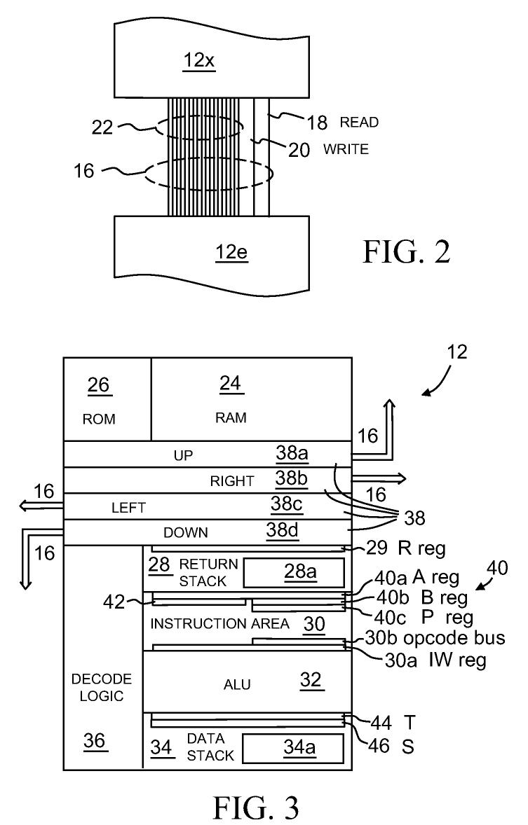

FIG. 2 is a more detailed view of a portion of FIG. 1 showing a portion of computers 12x and 12e, and details of the interconnecting data bus 16 between the two computers, as an example of all interconnecting buses 16 on chip 14. The view of FIG. 2 also reveals that the data buses 16 each have a read line 18, a write line 20 and a plurality (eighteen, in this example) of data lines 22. The data lines 22 are capable of transferring all the bits of one eighteen-bit data or instruction word generally simultaneously in parallel. It should be noted that, in one embodiment of the invention, some of the computers 12 are mirror images of adjacent computers. However, whether the computers 12 are all oriented identically or as mirror images of adjacent computers is not an aspect of this presently described invention. Therefore, in order to better describe this invention, this potential complication will not be discussed further herein.

According to the present inventive method, a computer 12, such as the computer 12e can set high one, two, three or all four of its read lines 18 such that it is prepared to receive data from the respective one, two, three or all four adjacent computers 12. Similarly, it is also possible for a computer 12 to set one, two, three or all four of its write lines 20 high. It should be noted that in the embodiment described, receiving (of data or instructions) is generally accomplished by “fetch” (also referred to as “read”) instructions, and transmitting is accomplished by “store” (also referred to as “write”) instructions. When one of the adjacent computers 12a, 12x, 12c or 12d, for example 12x sets a write line 20 between itself and the computer 12e high, if the computer 12e has already set the corresponding read line 18 high, then a word is transferred from computer 12x to computer 12e on the associated data lines 22. Then, the sending computer 12x will release the write line 20 and the receiving computer (12e in this example) resets (pulls low) both the write line 20 and the read line 18. The latter action will acknowledge to the sending computer 12 that the data has been received. Note that the above description is not intended necessarily to denote the sequence of events in order. In this embodiment, if the receiving computer 12e tries to reset the write line 20 by pulling it low from one side slightly before the sending computer 12x releases (stops pulling high) the write line 20 from the other side, the line will stay high and not go low until 12x actually releases the line 20. It is not an error for both computers to read. Indeed this is the default condition. Eventually one will quit reading and write. Similarly, as discussed above, it is currently anticipated that it would be desirable to have a single computer 12 set more than one of its four write lines 20 high. It is presently anticipated that there will be occasions wherein it is desirable to set different combinations of the read lines 18 high such that one of the computers 12 can be in a wait state awaiting data from the first one of the chosen computers 12 to set its corresponding write line 20 high.

In the example discussed above, computer 12e was described as setting one or more of its read lines 18 high before an adjacent computer (selected from one or more of the computers 12a, 12x, 12c or 12d) has set its write line 20 high. However, this process can certainly occur in the opposite order. For example, if the computer 12e were attempting to write to the computer 12x, then computer 12e would set the write line 20 between computer 12e and computer 12x to high. If the read line 18 between computer 12e and computer 12x has then not already been set to high by computer 12a, then computer 12e will simply wait until computer 12x does set that read line 18 high. Then, as discussed above, when both of a corresponding pair of write line 18 and read line 20 are high the data awaiting to be transferred on the data lines 22 is transferred. Thereafter, the receiving computer 12 (computer 12x, in this example) sets both the read line 18 and the write line 20 between the two computers (12e and 12x in this example) to low as soon as the sending computer 12e releases the write line 20.

Whenever a computer 12 such as the computer 12e has set one of its write lines 20 high in anticipation of writing it will simply wait, using essentially no power, until the data is “requested”, as described above, from the appropriate adjacent computer 12, unless the computer 12 to which the data is to be sent has already set its read line 18 high, in which case the data is transmitted immediately. Similarly, whenever a computer 12 has set one or more of its read lines 18 to high in anticipation of reading it will simply wait, using essentially no power, until the write line 20 connected to a selected computer 12 goes high to transfer a data or instruction word between the two computers 12. It should be noted that any data sent may be received as data or instructions according to its use by the receiving computer.

As discussed above, there may be several potential means and/or methods to cause the computers 12 to function as described. However, in this present example, the computers 12 so behave simply because they are operating generally asynchronously internally (in addition to transferring data there-between in the asynchronous manner described). That is, instructions are generally completed sequentially. When either a write or read instruction occurs, there can be no further action until that instruction is completed (or, perhaps alternatively, until it is aborted, as by a “reset” or the like). There is no regular clock pulse, in the prior art sense. Rather, an enable pulse is generated to accomplish a next instruction only when the instruction being executed either is not a read or write type instruction (given that a read or write type instruction would require completion, often by another entity) or else when the read or write type operation is, in fact, completed.

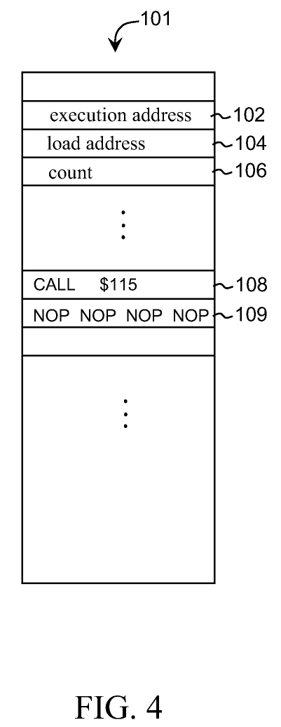

FIG. 3 is a block diagram depicting the general layout of an example of one of the computers 12 of FIGS. 1 and 2. As can be seen in the view of FIG. 3, each of the computers 12 is a generally self contained computer having its own RAM 24 and ROM 26. As mentioned previously, the computers 12 are also sometimes referred to as “nodes”, given that they are, in the present example, combined on a single chip.

Other basic components of the computer 12 are a return stack 28 (including an R register 29, discussed hereinafter), an instruction area 30, an arithmetic logic unit (ALU) 32, a data stack 34 and a decode logic section 36 for decoding instructions. One skilled in the art will be generally familiar with the operation of stack based computers such as the computers 12 of this present example. The computers 12 are dual stack computers having the data stack 34 and the separate return stack 28.

In this embodiment of the invention, the computer 12 has four communication ports 38, also called direction ports, for communicating with adjacent computers 12. The communication ports 38 are tri-state drivers, having an off status, a receive status (for driving signals into the computer 12) and a send status (for driving signals out of the computer 12). Of course, if the particular computer 12 is not on the interior of the array (FIG. 1) such as the example of computer 12e, then one or more of the communication ports 38 will not be used in that particular computer, at least for the purposes described above. However, those communication ports 38 that do abut the edge of the die 14 can have additional circuitry on the die, either designed into such computer 12 or else external to the computer 12 but associated therewith, to cause such communication port 38 to act as an external I/O port 39 (FIG. 1). Examples of such external I/O ports 39 include, but are not limited to, USB (universal serial bus) ports, RS232 serial bus ports, parallel communications ports, analog to digital and/or digital to analog conversion ports, and many other possible variations. No matter what type of additional or modified circuitry is employed for this purpose, according to the presently described embodiment of the invention the method of operation of the “external” I/O ports 39 regarding the handling of instructions and/or data received there from will be alike to that described, herein, in relation to the “internal” communication ports 38. In FIG. 1 an “edge” computer 12f is depicted with associated interface circuitry 80 (shown in block diagrammatic form) for communicating through an external I/O port 39 with an external device 82.

In the presently described embodiment, the instruction area 30 includes a number of registers 40 including, in this example, an A register 40a, a B register 40b and a P register 40c. In this example, the A register 40a is a full eighteen-bit register, while the B register 40b and the P register 40c are nine-bit registers.

Although the invention is not limited by this example, the present computer 12 is implemented to execute native Forth language instructions. As one familiar with the Forth computer language will appreciate, complicated Forth instructions, known as Forth “words” are constructed from the native processor instructions designed into the computer. The collection of Forth words is known as a “dictionary”. In other languages, this might be known as a “library”. As will be described in greater detail hereinafter, the computer 12 reads eighteen bits at a time from RAM 24, ROM 26 or directly from one of the data buses 16 (FIG. 2). However, since in Forth most instructions (known as operand-less instructions) obtain their operands directly from the stacks 28 and 34, they are generally only 5 bits in length, such that up to four instructions can be included in a single eighteen-bit instruction word, with the condition that the last instruction in the group is selected from a limited set of instructions having “0 0” in the two least significant bits, which are accordingly hard wired, for execution.

The instruction area 30 includes, in addition to the registers previously noted hereinabove, an eighteen-bit instruction word (IW) register 30a for storing the instruction word that is presently being used, and an additional 5-bits-wide opcode bus 30b for holding the particular (5-bit) instruction presently being executed. Also depicted in block diagrammatic form in the view of FIG. 3 is an instruction (also referred to as “slot”) sequencer 42 that can connect 5-bit instructions held in the IW register sequentially for execution, without memory access or involvement of the program counter, when appropriately enabled as noted herein above with reference to read and write instructions.

In this embodiment of the invention, data stack 34 is a last-in-first-out stack for parameters to be manipulated by the ALU 32, and the return stack 28 is a last-in first-out stack for nested return addresses used by CALL and RETURN instructions. The return stack 28 is also used by PUSH, POP and NEXT instructions, as will be discussed in some greater detail, hereinafter. The data stack 34 and the return stack 28 are not arrays in memory accessed by a stack pointer, as in many prior art computers. Rather, the stacks 34 and 28 are an array of registers. The top two registers in the data stack 34 are a T register 44 and an S register 46. The remainder of the data stack 34 has a circular register array 34a having eight additional hardware registers therein numbered, in this example S₂ through S₉. One of the eight registers in the circular register array 34a will be selected as the register below the S register 46 at any time, as a consequence of instruction execution; the value in a shift register that selects the stack register to be below S is a hardware function and cannot be read or written by software. Similarly, the top position in the return stack 28 is the dedicated R register 29, while the remainder of the return stack 28 has a circular register array 28a having eight additional hardware registers therein (not specifically shown in the drawing) that are numbered, in this example R₁ through R₈.

In this embodiment of the invention, there is no hardware detection of stack overflow or underflow conditions. Generally, prior art processors use stack pointers and memory management, or the like, such that an exception condition is flagged when a stack pointer goes out of the range of memory allocated for the stack. That is because, were the stacks located in memory, an overflow or underflow would overwrite, or use as a stack item, something that is not intended to be part of the stack, or require an adjustment in memory allocation. However, because the present invention has circular arrays 28a and 34a at the bottom on the stacks 28 and 34, overflow or underflow out of the stack area can not occur. Instead, the circular arrays 28a and 34a will merely wrap around cyclically. Because the stacks 28 and 34 have finite depth, pushing anything to the top of a stack 28 or 34 means something on the bottom can be overwritten if the stack is full. Pushing more than ten items to the data stack 34, or more than nine items to the return stack 28 must be done with the knowledge that doing so will result in overwriting the item at the bottom of the stack 28 or 34, and that the software developer is responsible for keeping track of the number of items on the stacks 28 and 34 and for not trying to put more items there than the respective stacks 28 and 34 can hold. However, it should be noted that the software can take advantage of the circular arrays 28a and 34a in several ways. As just one example, the software can simply assume that a stack 28 or 34 is ‘empty’ at any time. There is no need to clear old items from the stack as they will be pushed down towards the bottom where they will be lost as the stack fills. So there is nothing to initialize for a program to assume that the stack is empty.

To better understand the stream loader of the invention a number of specialized terms are used. The definition of these terms follows. It should be noted that for brevity, the term node is used herein after to refer to a computer 12 of array 10.

I/O Node: Certain nodes are connected to external pins and can perform I/O functions such as serial I/O and SPI. We will call these I/O Nodes.

Stream: A serial bit stream of digital information, generally comprising both instructions and data, and having a given length, which can be decoded into a respective number of 18-bits long words in the I/O Node. A stream typically includes a nested sequence of segments, which include payloads, and “wrapper” instructions and data preceding and following each payload. The term payload refers to information, including a program of Forth code and data, for storage in a node, execution in a node, and/or transmission to other nodes. Wrappers provide for handling the respective payloads by a node.

Root Node: The I/O Node into which the stream is inserted is called the Root Node.

Stream Path: The order in which the stream passes through nodes is called the Stream Path. The first node in the Stream Path is the Root node.

Port Execution: A node can point its program counter (P register) to the address of a port by executing a branch to that address. When P is pointed at a port then the next instruction fetch will cause the node to sleep pending the arrival of data on the port. When the data arrives, it will be placed into the instruction word (IW) register and executed just as if it had come from RAM or ROM. In normal operation P is automatically incremented after an instruction word is loaded into the IW register from memory, but when P is pointing to a port, the auto-incrementing of P is suppressed so that subsequent instruction fetches will use the same port address. Additionally, instructions which would normally increment P (such as @p+) will have the increment operation suppressed. While in this state, a node executes everything which is sent to the port it is fetching from. This state can be exited by sending a branch instruction in the stream, such as a jump, a call or a return.

PAUSE: Pause is the name of a function which a node uses to scan its ports and check for incoming streams. It examines the ports in a particular order, and expects that a suitable code sequence or word awakens the node, followed by a stream of executable code and data on the same port. Pause itself receives and analyzes the content of an IOCS register (which contains information telling which ports are active, i.e., which ports have reads and writes pending from neighboring computers), so that it can tell which direction port the stream is coming from. When we refer to using Pause, we usually mean in the context of a function called Warm.

WARM: Warm is a loop a node enters when it wants to look for work to do. The work will come in through one of the node's ports. Warm will perform a MultiPort fetch (read), which will cause the node to sleep pending a write (store) to one of the ports addressed by the MultiPort fetch. When a word arrives on a port, in form of a write (store) instruction to the port and awakens the node, Warm will read the IOCS register and send this information to Pause. In the present embodiment, a node executing a MultiPort fetch will ignore the first word that can be fetched, and accordingly, the stream which awakens a node in this condition is expected to begin with a word that can be ignored. Neither Warm nor Pause is interested in the content of the first word in the stream. It only exists to complete a pending read (fetch) on a port of a node, with a write (store) to the same port from a neighboring node, thereby waking the node. The next word in the stream must follow immediately, in form of a write (store) instruction, because when Warm reads IOCS after waking from the port read, it is expected that the second word in the stream will have arrived so that the IOCS bits will already reflect its presence (in form of a pending write from the neighbor). This background is useful in order to understand how a pausing node interprets the start of a stream as it first arrives.

MultiPort Execution: The addresses of ports are encoded in such a way that one address can contain bits which specify as many as 4 ports. A MultiPort address is an address in which more than one port address bit is active. MultiPort execution occurs when the a node is performing Port Execution and the address in the program counter is a MultiPort Address. It is required that only one Neighbor node send code to a node which is performing MultiPort execution. The purpose of MultiPort execution is to allow a node to accept work from any direction.

Port Pump: When a node executes a loop which reads data from one port and sends data to another port, we call this a port pump. Additionally either the source or destination address may increment over the RAM and still be called a port pump. There are several kinds of port pumps that may differ in their form and purpose. If normal branching or looping commands are used, then the pump must reside in RAM or ROM. If micro-next is used for the loop, and especially if the loop instruction is executed from within a port, then no assistance from RAM or ROM are required. This is the form most usually meant when referring to a Port Pump. The Port Execution Port Pump has the useful property that the P register can be used to address at least one (and possibly both) of the directions. If the P register is used for both directions it is called a MultiPort Address Port Pump. This pump uses the same address for the read address and the write address, and so is a more efficient use of node resources. However it requires careful coordination so that the input direction is active during the reads and the output direction is active during the writes.

Domino Awakening: A method of starting all the nodes after their initialization by sending a wake-up signal which gets passed from node to node. When nodes are initialized they are put to sleep until the signal awakens them, preventing program code from interfering with the loading and initialization of other nodes.

Domino Path: The order in which nodes are awakened. This is not necessarily the same as the Stream Path and may include additional nodes. However, as it passes through a given node, the Domino Path must include that port which was the entry port for the Stream Path for that node.

Pinball: The word which is sent from node to node, following the Domino Path, to cause the various nodes to awaken.

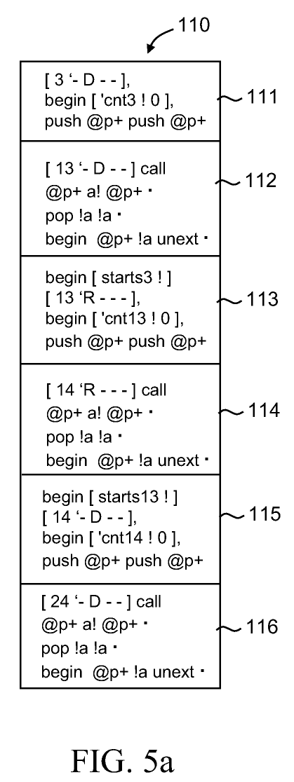

The first step in operation of a stream loader 100 according to an embodiment of the invention is starting a stream, for example stream 101 which is depicted symbolically in FIG. 4. A Stream Path 84 is shown in FIG. 1. It is expected that every node 12 in the Stream Path 84 to begin with is in one of two states, either waiting at a MultiPort fetch in Warm, or executing MultiPort branch. In both of these cases the MultiPort address would include the port through which the stream will enter. This is a normal reset condition in the current embodiment. All nodes 12 will either be running Warm or will be in a MultiPort JUMP.

The stream 101 is first delivered to an I/O Node, in this example, node 12f, using SPI protocol, and 12f will be the Root Node for this stream. An I/O Node expects to receive three words of information namely, execution address 102, load address 104 and count (stream length) 106.

In the case of the stream loader, the load address 104 will be the address of the port which connects the Root Node to the next node in Stream Path 84. It will be assumed in this embodiment and for purposes of this example that the communication ports 38 between computers 12 are identified according to direction designations indicated by the letters R,D,L,U in FIG. 1, which in this embodiment have addresses $1D5, $115, $175, and $145 respectively. In another embodiment, the ports can be identified as north, south, east, and west ports. Accordingly for Root Node 12f, the D (Down) port with address $115 will connect to node 12b. In this example node 12f will pass the stream to its D port, so the stream will begin execution in node 12b.

Continuing with the example of a stream which enters using node 12f as a Root Node, and is sent to the D port, thereby executing in node 12b; it should be mentioned that the stream entering node 12b will include instructions which will cause node 12b to send most of the stream on to the next node 12c in the Stream Path 84. Bearing in mind that node 12b will be executing either Warm or a MultiPort Jump, it must be awakened it in a way which works for both cases. Therefore the first action of a nest is to send two executable words 108, 109 in rapid succession. The first, 108, will be a call to the port being used to enter the node, which in case of stream path 84 is the D port as noted herein above, and the second, 109, will consist of four NOP instructions (also called nops). The effect of the call must be considered from the point of view of Warm, and of the MultPort jump. If the node is waiting in warm, then the “call” word will wake the node, but the call instruction itself will be dropped, because Warm drops the data which awakens it. On wake up, Warm calls Pause, and Pause will notice which direction the data came from, and make a call to that port, thus resulting in a call to the port which is sending the stream, which is the same as word 108. If the node is performing a MultiPort jump instead of waiting in Warm, then word 108 will be executed. In either case the program counter of node 12b will be pointed at the D port.

The call to the port through which we are entering may appear redundant at first. However, it serves two purposes. It makes sure that while the stream is entering the node only the port we want to use is reading (turning off the effect of a MultiPort jump). Also, the call will cause the address of the instruction of whatever the node 12b was doing to be placed on the return stack, i.e., in R-register 29. Therefore if R-register is not changed during initialization this node will go back to its MultiPort jump when the stream loading process is done. If the node was executing Pause, then it will return to Pause at the end of stream loading (and that happens only if we do not initialize the R-register to point to application code).

Getting back to the example; after the call has focused the attention of node 12b to its D port, node 12b will be told to fetch a literal value using the P register as a pointer, thus allowing the next word in the stream to be data. This data item will appear on node 12b's data stack 34. Node 12b will then be told to use the a! instruction to place this value in the A register. This process can be used to set node 12b's A register to point to the next node 12c in Stream Path 84, so a loop using @p+ !a+ will read data from source 12f, termed the upstream side of Stream Path 84, and send the stream to 12c, termed the downstream side. By appropriate calculation of the lengths of the stream data segments each node can be adapted to execute commands long enough to load a port pump into memory, and then send data downstream until all the downstream ports have been fed. Finally, more commands will arrive to be executed, and these commands will cause the initialization of the RAM 24 and registers of a node.

Once all of the programs have been delivered to nodes 12, and the registers have been initialized, each node can begin performing its appointed task. However, the performance of that task is likely to involve using ports to communicate with neighbors. Therefore a given node should not begin until all of nodes 12 have been given their respective tasks, and are also waking up and starting the application. Therefore there are two requirements here. First each node should go to sleep after it is initialized. Second, all nodes 12 should awaken at (relatively) the same time, without interfering with the initialization performed for those nodes. The Domino Awakening process of the invention is designed to accomplish this, so that a given node such as 12c can wake up more than one neighbor node i.e. 12b, 12g, 12d, and 12h, allowing a rapid spread of the wake-up signal. According to the domino awakening process, nodes are put to sleep after they are initialized by executing a call to a MultiPort address. This address must include the address of each port to which the Pinball awakening word will be sent, and also the address of the port from which the node was initialized. Then a word which does a fetch on that MultiPort address can be sent. This will cause a node, for example 12c, to sleep pending the arrival of data on one of the specified ports. No more data will be sent to node 12c until it is desired that node 12c wakes up. When the Pinball eventually arrives, the instruction word which includes the fetch instruction will also perform a subsequent store to the next node 12d or nodes to be awakened. Because this instruction word sleeps until the wake-up data arrives, then passes the wake-up data to the next node 12d then enters the current node's 12c application, the process is called Domino Awakening.

A domino is a sequence of two instruction words. The first word causes the node 12 to focus its attention on a Domino Path 88, identified in FIG. 1 (i.e. Jump to a MultiPort address which consists of all the ports in the Domino Path with respect to this node). The second word contains one of the following sequences: @p+ !p+ (normal Domino), @p+ !p+ ; (penultimate Domino) or @p+ drop; (end Domino). The @p+ word will cause the node to wait for a “pinball” to come to it on Domino Path 88. The Domino Path 88 as shown in FIG. 1 is assumed to coincide partially with stream path 84, and includes also nodes 12i and 12h.

Note that the normal Domino word ( . . @p+ !p+ ) begins with two nops ( . . ). This is so that after the Pinball is sent on using !p+ the node which sent the Pinball downstream will immediately be looking for a new instruction and therefore it will see the reflected Pinball coming to it via the MultiPort write which the downstream node performs. If the sending node does not pay attention to its ports immediately, the reflected Pinball may not be seen, because the write performed by the downstream node will be satisfied by the node or nodes downstream from it.

A Pinball is a RETURN instruction in the stream, also denoted by ; (semicolon). The appearance of the Pinball will satisfy the read caused by the @p+ against the MultiPort jump's P address, and the remainder of the Domino will be executed (usually !p+). The !p+ will cause the Pinball to be sent to all the ports included in Domino Path 88 for the affected node. Therefore a MultiPort write will occur. This write will send the Pinball to those nodes which are “downstream” in the Domino Path, thereby waking them.

The MultiPort write will also send the Pinball back to the node which awakened the current node. Since that node will still have its program counter focused on the Domino Path, the Pinball will be executed. Since the Pinball is a RETURN instruction, the node which receives the reflected Pinball will execute the instruction at the address specified in the R-register. This address will either be the address specified as the Start Address, or if no Start Address has been specified, it will be the address of what the node was doing when the stream first arrived; i.e. Pause or a MultiPort branch. It is important to note that the acceptance of the reflected Pinball causes the write to that port to be completed. If we did not use the Pinball as the return command, then the node sending the Pinball would have an unsatisfied write pending in the upstream direction of the Domino.

In the case of the final node in a Domino Path, there is no node to which the Pinball must be sent, while there is often a direction to which the Pinball must not be sent. Therefore there is no !p+ in this node's Domino instruction. Instead, the end-Domino (specified by the word edomino in the program) will include . @p+ drop ;. Note two differences. The Pinball is dropped because it is not needed anymore, and there is a ; at the end. This ; exists because there is no downstream node to reflect the Pinball back for the purpose of sending the end node to its code.

There is one more special case. The second to the last domino in the path (the penultimate Domino) will not receive a reflected Pinball, because the last Domino does not reflect it with a !p+. Therefore the penultimate Domino (specified by the word pdomino in the program) will include . @p+ !p+ ;.

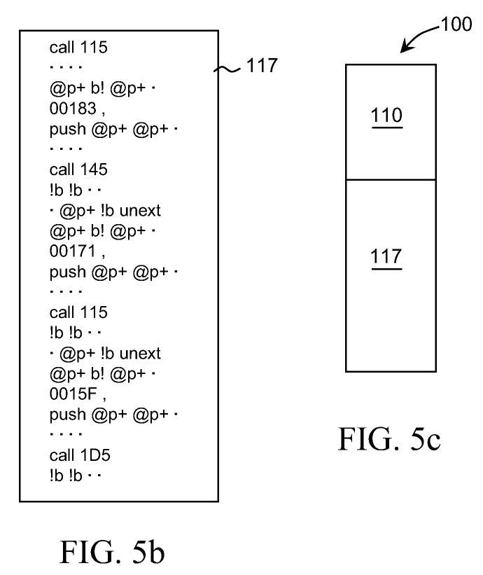

FIG. 5a illustrates a segment of source code in machine Forth, including a Domino portion 110, for a stream loader 100 according to an embodiment of the invention. The words after the slash (/) are comments and not executed. The Domino portion 110 includes 6 dominoes 111-116. The first domino 111 executes on processor 12f either on RAM 24 or port 38d. The first instruction [3 ′- D - -], sets the the direction of 12f's pump to 12b. The second instruction, begin [‘cnt3 ! 0], initiates operation of the domino and tells how much data to send to node 12b. The final instruction of domino 111, push @p+ push @p+, gets the wake data as described above.

The second domino 112 is a Port Execution Port Pump. The first instruction, [13 ′- D - -] call, acts to awaken the port it is ignored by pause and returns if port jump. The second instruction @p+ a! @p+ . begins 13's port pump as described above. The third instruction, pop !a !a ., acts to ship the wake data. The final instruction, begin @p+ !a unext ., writes the following data to 12f's port.

The third domino 113 is the start of the stream segment which goes to node 12b. The first instruction, begin [starts3 !], initiates 12f's stream to 12b and starts here. The second instruction, [13 ′R - - -], sets the direction of 12b's pump to 12c. The third instruction, begin [‘cnt13 ! 0], tells node 12b to send this much data. The final instruction, push @p+ push @p+, gets the wake data as described above.

The fourth domino 114 is a Port Execution Port Pump executed on node 12c. The first instruction, [14 ′R - - -] call, acts to awaken the port but is ignored by pause then, returns if port jump. The second instruction, @p+ a! @p+ . begins 12c's port pump. The instruction, pop !a !a . , ships the wake data as described above. The final instruction, begin @p+ !a unext . , writes following data to 12c's port.

The fifth domino 115 defines the start of the stream which goes to node 12g. The first instruction, begin [starts13 !] tells where 12c's stream to 12g starts. The direction is specified in the next instruction and the length in the third instruction. As above the last instruction pushes the amount of data specified and gets the wake data.

The final domino 116 is a Port Execution Data Pump to RAM 24 on node 12g. The first instruction, [24 ′- D - -] call is a wakeup, ignored by pause and returns if port jump it specifies the direction north. The second instruction starts 12g's port-pump. Sets the direction and gets the count instruction telling how much data to ship. The third instruction ships the wake data. The last instruction, begin @p+ !a unext ., writes a second portion 117 of Forth code instructions and data shown in FIG. 5b, comprising a payload segment, to 12g's port. FIG. 5c further shows the concatenation of code portions 110, 117.

The first step in operation of the stream loader 100 and its preparation is to specify initial contents of Data Stack 34, Return Stack 28, as well as A and B register contents. The runtime start address is also specified. This can be accomplished with the code shown in Example 1 below.

### EXAMPLE 1

8 org here =pc
1 $a3 $a4 $a5 $a6 $a7 $a8 7 >rtn
$1000 $2000 2 >stk
‘r--- =a
‘r--- =b

The code is then tested; one approach is to use a simulator to test the code. The simulator will initialize registers and stacks as specified above.

The next step is to specify a load order for a stream. The code of Example 2 illustrates one method:

### EXAMPLE 2

10 :rnode 10 20 stream-loader ( 20)
nestEast nestSouth nestEast nestEast nestEast nestEast
nestEast ( 16)

A stream compiler will create a stream suitable for loading through port execution. The stream compiler will do this by performing the following actions. First, the stream compiler examines the RAM content of each node, i.e., the instructions and data to be stored into local memory, and includes in the stream instructions to load, only for those nodes that need to store instructions or data. The stream compiler next includes instructions to initialize the Stacks, the A and B registers, and the return stack 28 so that the node will begin executing at the specified address.

Finally the stream compiler specifies the domino path. This specification is done as described in Example 3:

### EXAMPLE 3

( 16) ~west edomino ( 15)
( 15) ~east ~west pdomino ( 14)
( 14) ~east ~west domino ( 13)
( 13) ~east ~west domino ( 12)
( 12) ~east ~west domino ( 11)
( 11) ~east ~west port-done

The concept of a Current Node or Consumer Node may be useful (as an additional definition). When the stream is in motion (and before the Pinball is released), during operation of the stream loader, there is always one and only one Current Node. This is defined as the node which consumes the stream where consumption is understood to mean interpreting the stream via the IW or storing it more permanently into RAM, a stack or an address register within that node. If a node is executing a micro-looping two-port pump then it is no longer considered to be the Current Consumer Node. If it is running a pump to its own RAM then it is the consumer. While setting up for a pump, or initializing registers, or configuring the Domino Path, a node is current. This definition allows meaningful use of the words “current” or “consumer” wherever appropriate. These terms can then be used to identify the parts of a stream by its “owner”, target, user, or simply its consumer node.

Caveats on the Use of Multi Port Operations:

The handshake logic that detects a combination of read and write requests, and which generates the wakeup/proceed signal in response, exists in circuit portions (also referred to as logic) within the area of the chip 14 between each pair of nodes. The wakeup/acknowledge signal is passed from this logic back to each node in the pair.

In one embodiment of the invention it is logic within the reading node (not common logic between the nodes) that is responsible for pulling down both the read and the write request signals. This means that, by design, a node that is doing a multiport write doe not have full control of the write request line, and any unsatisfied write directions will leave their write request line tristate but fully charged in the asserted state. Any node reading from such node “soon after” will have their read completed even though the data are lost (but the late node's write request will finally be cleared).

In the above embodiment it is the responsibility of the reading node to forward the acknowledge signal to each of that node's ports that are involved in a multiport read in order to clear those read requests. If the domino chain's ends are coincident with endpoints in a forked fill stream such a forked fill design simplifies implementation. In a multiport read only one port will ever acknowledge, but during a multiport write we expect that multiple directions will complete and acknowledge simultaneously. This makes it easy to prove that when the read complete logic in a node is used to clear the other outstanding direction's requests, that no conflict or race in signals will occur. When a write completes in the presence of other outstanding writes, it is expected that they should all be completing at the same time.

Various modifications may be made to the invention without altering its value or scope. For example, while this invention has been described herein using the example of the particular computers 12, many or all of the inventive aspects are readily adaptable to other computer designs, other sorts of computer arrays, and the like.

Similarly, while the present invention has been described primarily herein in relation to communications between computers 12 in an array 10 on a single die 14, the same principles and methods can be used, or modified for use, to accomplish other inter-device communications, such as communications between a computer 12 and its dedicated memory or between a computer 12 in an array 10 and an external device.

The machine Forth code following in Example 4 is functional to compile a stream to pass through all 40 nodes of a 40 node processor. Material prefaced with a front slash (\) is a comment and is not processed.

### EXAMPLE 4

```
: v.ROM ( - a u) s“ ../../../t18/c7Fr01/” ;
true constant sim? v.ROM +include“ ROMconfig.f”
04 {node node}
08 {node node}
09 {node begin 2* not push unext node}
13 {node node}
14 {node 0 =a node}
15 {node 0 =b node}
16 {node 0 1 >rtn node}
17 {node 6 =pc node}
18 {node 12 13 2 >stk node}
19 {node 1 org here =pc
  begin 2* not push unext + + + + . . . . node}
23 {node 0 org here =pc 1 =a 2 =b 3 4 2 >rtn 5 6 7 3 >stk
  begin 2* not push unext . . . . node} \ extra word for even substream
24 {node node}
25 {node node}
26 {node begin 2* not push unext node}
27 {node node}
28 {node node}
29 {node node}
39 {node node}
```

In order to compile a port-stream to the external buffer the machine Forth code in Example 5 may be used.

### EXAMPLE 5

| | |
|---|---|
| 0 | :xnode 19 >root |
| | 18 17 16 15 14 13 6 >branch <init 04 >node <node 2 <branch |
| | 26 25 24 23 4 >branch 6 <branch |
| | 28 27 2 >branch 3 <branch |
| | 09 08 2 >branch 2 <branch |
| | 29 39 2 >branch 2 <branch |
| | <init |

The machine Forth code in Example 5 will cause the loader to follow the following path through the processor.

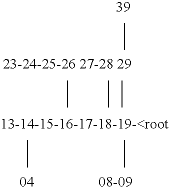

In order to annotate the stream as documentation the code in Example 6 is applicable. In viewing this code number in the second column gives the node number which will execute the code. Note that | in second column indicates “payload” (or domino) that changes node state. A* in second column indicates the last execution before awaiting the pinball arrival.

### EXAMPLE 6

hex 0 here .adrs decimal
0 [IF]

| | | |
|---|---|---|
| 000 19 | 2LQK 10080 | \First substream (next at 0D3) |
| 001 | AKG0 001D5 | |
| 002 | AL68 00067 | |
| 003 18 | 3KG0 121D5 call 1D5 | \First call into node is for focus (& defalt pc) |
| 004 | SSSS 2C9B2 . . . . | \Note nops word is deleted if needed |
| 005 | 8U8S 04B12 @p+ b! @p+ . | \to make substream odd (see stream @ 0D6) |
| 006 | AK40 00175 | |
| 007 | ALUG 000A1 | |
| 008 | T8S8 2FDB7 push @p+ . @p+ | |
| 009 17 | SSSS 2C9B2 . . . . | \(Executed |
| 00A | 3K40 12175 call 175 | \ ... |
| 00B 18 | EESS 09BB2 !b !b . . | \ later) |
| 00C | 8ES4 05BB4 @p+ !b . unext | \Pumps following A2 words |
| 00D 17 | 8U8S 04B12 @p+ b! @p+ . | \etc., etc. |
| 00E | AKG0 001D5 | \ ... |
| 00F | ALOO 00093 | |
| 010 | T8S8 2FDB7 push @p+ . @p+ | |
| 011 16 | SSSS 2C9B2 . . . . | |
| 012 | 3KG0 121D5 call 1D5 | |
| 013 17 | EESS 09BB2 !b !b . . | |
| 014 | 8ES4 05BB4 @p+ !b . unext | |
| 015 16 | 8U8S 04B12 @p+ b! @p+ . | |
| 016 | AK40 00175 | |
| 017 | ALE0 00025 | |
| 018 | T8S8 2FDB7 push @p+ . @p+ | |
| 019 15 | SSSS 2C9B2 . . . . | |
| 01A | 3K40 12175 call 175 | |
| 01B 16 | EESS 09BB2 !b !b . . | |
| 01C | 8ES4 05BB4 @p+ !b . unext | |
| 01D 15 | 8U8S 04B12 @p+ b! @p+ . | |
| 01E | AKG0 001D5 | |
| 01F | AL9G 00019 | |
| 020 | T8S8 2FDB7 push @p+ . @p+ | |
| 021 14 | SSSS 2C9B2 . . . . | |
| 022 | 3KG0 121D5 call 1D5 | |
| 023 15 | EESS 09BB2 !b !b . . | |
| 024 | 8ES4 05BB4 @p+ !b . unext | |
| 025 14 | 8U8S 04B12 @p+ b! @p+ . | |
| 026 | AK40 00175 | |
| 027 | ALAG 00001 | |
| 028 | T8S8 2FDB7 push @p+ . @p+ | |
| 029 13 | SSSS 2C9B2 . . . . | |
| 02A | 3K40 12175 call 175 | |
| 02B 14 | EESS 09BB2 !b !b . . | |
| 02C | 8ES4 05BB4 @p+ !b . unext | |
| 02D 13* | 8SSS 049B2 @p+ . . . | \Finally some node init, |
| 02E | AK10 0015D | \only domino init is needed (pc from focus) |
| 02F 14 | 8U8S 04B12 @p+ b! @p+ . | |
| 030 | AK80 00115 | |
| 031 | ALAG 00001 | |
| 032 | T8S8 2FDB7 push @p+ . @p+ | |
| 033 04 | SSSS 2C9B2 . . . . | |
| 034 | 3K80 12115 call 115 | |
| 035 14 | EESS 09BB2 !b !b . . | |
| 036 | 8ES4 05BB4 @p+ !b . unext | |
| 037 04* | 8SSS 049B2 @p+ . . . | \Same for node 04 as |
| 038 | AK10 0015D | \* marks last inst, next fetch is pinball |
| 039 14 | 8V8S 04A12 @p+ a! @p+ . | \=a init, |
| 03A | ALAK 00000 | |
| 03B | AKC0 00135 | \b is set to pass pinball |
| 03C * | U88S 29D12 b! @p+ @p+ . | \(to 04 and 13) |
| 03D | AK10 0015D | \Default b restore value |
| 03E | ONU0 242A5 dup drop b! ; | \Downstream pinball (04,13) |
| 03F 15* | 8U88 04B17 @p+ b! @p+ @p+ | \Setup |
| 040 | AKG0 001D5 | \for domino |
| 041 | ALAK 00000 | \=b setup in domino (pc from f |
| 042 | EU0S 08B52 !b b! ; | \pinball for 14 |
| 043 16 | 8U8S 04B12 @p+ b! @p+ . | \A branch at node 16 builds outward again |
| 044 | AK20 00145 | |
| 045 | AL34 0004C | |
| 046 | T8S8 2FDB7 push @p+ . @p+ | |
| 047 26 | SSSS 2C9B2 . . . . | |
| 048 | 3K20 12145 call 145 | |
| 049 16 | EESS 09BB2 !b !b . . | |
| 04A | 8ES4 05BB4 @p+ !b . unext | |
| 04B 26 | 8U8S 04B12 @p+ b! @p+ . | |
| 04C | AK40 00175 | |
| 04D | ALDS 0003A | |
| 04E | T8S8 2FDB7 push @p+ . @p+ | |
| 04F 25 | SSSS 2C9B2 . . . . | |
| 050 | 3K40 12175 call 175 | |
| 051 26 | EESS 09BB2 !b !b . . | |
| 052 | 8ES4 05BB4 @p+ !b . unext | |
| 053 25 | 8U8S 04B12 @p+ b! @p+ . | |
| 054 | AKG0 001D5 | |
| 055 | ALFC 0002E | |
| 056 | T8S8 2FDB7 push @p+ . @p+ | |
| 057 24 | SSSS 2C9B2 . . . . | |
| 058 | 3KG0 121D5 call 1D5 | |
| 059 25 | EESS 09BB2 !b !b . . | |
| 05A | 8ES4 05BB4 @p+ !b . unext | |
| 05B 24 | 8U8S 04B12 @p+ b! @p+ . | |
| 05C | AK40 00175 | |
| 05D | ALES 00022 | |
| 05E | T8S8 2FDB7 push @p+ . @p+ | |
| 05F 23 | SSSS 2C9B2 . . . . | |
| 060 | 3K40 12175 call 175 | |
| 061 24 | EESS 09BB2 !b !b . . | |
| 062 | 8ES4 05BB4 @p+ !b . unext | |
| 063 23 | 8V8S 04A12 @p+ a! @p+ . | \Last node in branch begins init |
| 064 | ALAK 00000 | |
| 065 | ALAG 00001 | |
| 066 | TSSS 2E9B2 push . . . | |
| 067 | 8DS4 058B4 @p+ !a+ . unext | |
| 068 RM | HJT4 366BC 2* not push unext | \First some RAM content |
| 069 | SSSS 2C9B2 . . . . | |
| 06A 23 | 8888 05D17 @p+ @p+ @p+ @p+ | \Then >rtn setup |
| 06B | ALAO 00003 | |
| 06C | ALA4 00004 | |
| 06D | 0000 15555 | |
| 06E | 0000 15555 | |
| 06F | 8888 05D17 @p+ @p+ @p+ @p+ | |
| 070 | 0000 15555 | |
| 071 | 0000 15555 | |
| 072 | 0000 15555 | |
| 073 \| | 0000 15555 | |
| 074 \| | TTTS 2E8BA push push push . | |
| 075 \| | TTTS 2E8BA push push push . | |
| 076 \| | TT88 2E817 push push @p+ @p+ | \Switch to >stk setup mid word |
| 077 \| | 0000 15555 | |
| 078 \| | 0000 15555 | |
| 079 \| | 8888 05D17 @p+ @p+ @p+ @p+ | |
| 07A \| | 0000 15555 | |
| 07B \| | 0000 15555 | |
| 07C \| | 0000 15555 | |
| 07D \| | 0000 15555 | |
| 07E \| | 8888 05D17 @p+ @p+ @p+ @p+ | \Last literal is for =a |
| 07F \| | ALA8 00007 | |
| 080 \| | ALAC 00006 | |
| 081 \| | ALA0 00005 | |
| 082 \| | ALAG 00001 | |
| 083 * | V8T8 2BDBF a! @p+ push @p+ | \then =pc then =b |
| 084 \| | ALAK 00000 | |
| 085 \| | ALAS 00002 | |
| 086 24* | 8U88 04B17 @p+ b! @p+ @p+ | \This passover node leaves only default |
| 087 \| | AK40 00175 | \Temp b |
| 088 \| | AK10 0015D | \“Restore” b (pc from focus) |
| 089 \| | ONU0 242A5 dup drop b! ; | \Pinball for 23 is “final” |
| 08A 25* | 8U88 04B17 @p+ b! @p+ @p+ | \Same as node 24 |
| 08B \| | AKG0 001D5 | |
| 08C \| | AK10 0015D | |
| 08D \| | EU0S 08B52 !b b! ; | \but pinball to 24 is “interior” |
| 08E 26 | 8V8S 04A12 @p+ a! @p+ . | \A code only node (pc from focus) |
| 08F | ALAK 00000 | \location zero |
| 090 | ALAK 00000 | \get |
| 091 | TSSS 2E9B2 push . . . | |
| 092 | 8DS4 058B4 @p+ !a+ . unext | |
| 093 RM\| | HJT4 366BC 2* not push unext | \“patch code” (pc will return to “pause” |
| process) | | |
| 094 26* | 8U88 04B17 @p+ b! @p+ @p+ | \Simple interior domin |
| 095 \| | AK40 00175 | |
| 096 \| | AK10 0015D | |
| 097 \| | EU0S 08B52 !b b! ; | \Pinball for 25 |
| 098 16\| | 8888 05D17 @p+ @p+ @p+ @p+ | \Node 16 gets >rtn content only, |

| | | |
|---|---|---|
| 099 \| | ALAK 00000 | \no pc or any code (go figur |
| 09A \| | 0000 15555 | |
| 09B \| | 0000 15555 | |
| 09C \| | 0000 15555 | |
| 09D \| | 8888 05D17 @p+ @p+ @p+ @p+ | |
| 09E \| | 0000 15555 | |
| 09F \| | 0000 15555 | |
| 0A0 \| | 0000 15555 | |
| 0A1 \| | 0000 15555 | |
| 0A2 \| | TTTS 2E8BA push push push . | |
| 0A3 \| | TTTS 2E8BA push push push . | |
| 0A4 \| | TT8S 2E812 push push @p+ . | |
| 0A5 \| | AK60 00165 | \Domino path |
| 0A6 * | U88S 29D12 b! @p+ @p+ . | \ into b, |
| 0A7 \| | AK10 0015D | \ new b |
| 0A8 \| | EU0S 08B52 !b b! ; | \ Pinball to 15, 26 |
| 0A9 17\| | 8T8S 04812 @p+ push @p+ . | \Change pc only |
| 0AA \| | ALAC 00006 | \ to this |
| 0AB \| | AKG0 001D5 | \ Then rest of regular |
| 0AC * | U88S 29D12 b! @p+ @p+ . | \ interior domino |
| 0AD \| | AK10 0015D | |
| 0AE \| | EU0S 08B52 !b b! ; | \Pinball for 16 |

| | | |
|---|---|---|
| 0AF 18 | 8U8S 04B12 @p+ b! @p+ . | \Short branch at 18 |

| | | |
|---|---|---|
| 0B0 | AK20 00145 | \ is “left as an exercise” |
| 0B1 | ALB0 0000D | |
| 0B2 | T8S8 2FDB7 push @p+ . @p+ | |
| 0B3 28 | SSSS 2C9B2 . . . . | |
| 0B4 | 3K20 12145 call 145 | |
| 0B5 18 | EESS 09BB2 !b !b . . | |
| 0B6 | 8ES4 05BB4 @p+ !b . unext | |
| 0B7 28 | 8U8S 04B12 @p+ b! @p+ . | |
| 0B8 | AK40 00175 | |
| 0B9 | ALAG 00001 | |
| 0BA | T8S8 2FDB7 push @p+ . @p+ | |
| 0BB 27 | SSSS 2C9B2 . . . . | |
| 0BC | 3K40 12175 call 175 | |
| 0BD 28 | EESS 09BB2 !b !b . . | |
| 0BE | 8ES4 05BB4 @p+ !b . unext | |
| 0BF 27* | 8SSS 049B2 @p+ . . . | |
| 0C0 \| | AK10 0015D | |
| 0C1 28* | 8U88 04B17 @p+ b! @p+ @p+ | |
| 0C2 \| | AK40 00175 | |
| 0C3 \| | AK10 0015D | |
| 0C4 \| | ONU0 242A5 dup drop b! ; | |

| | | |
|---|---|---|
| 0C5 18\| | 8888 05D17 @p+ @p+ @p+ @P+ | \ Then “content” for 18 is >stk |
| 0C6 \| | 0000 15555 | |
| 0C7 \| | 0000 15555 | |
| 0C8 \| | 0000 15555 | |
| 0C9 \| | 0000 15555 | |
| 0CA \| | 8888 05D17 @p+ @p+ @p+ @p+ | |
| 0CB \| | 0000 15555 | |
| 0CC \| | 0000 15555 | |
| 0CD \| | 0000 15555 | |
| 0CE \| | ALB0 0000D | |
| 0CF * | 88U8 05DA7 @p+ @p+ b! @p+ | |
| 0D0 \| | ALB4 0000C | |

| | | |
|---|---|---|
| 0D1 \| | AK60 00165 | \Note domino path splits (17,28) |
| 0D2 \| | AK10 0015D | |
| 0D3 19 | 2LQK 10080 | \ Second root substream (next at 0FB) |
| 0D4 | AK80 00115 | |
| 0D5 | ALBG 00009 | |
| 0D6 09 | 3K80 12115 call 115 | \ Stream forced even by removing four nops |
| 0D7 | 8U8S 04B12 @p+ b! @p+ . | |
| 0D8 | AKG0 001D5 | |
| 0D9 | ALAG 00001 | |
| 0DA | T8S8 2FDB7 push @p+ . @p+ | |
| 0DB 08 | SSSS 2C9B2 . . . . | |
| 0DC | 3KG0 121D5 call 1D5 | |
| 0DD 09 | EESS 09BB2 !b !b . . | |
| 0DE | 8ES4 05BB4 @p+ !b . unext | |
| 0DF 08* | 8SSS 049B2 @p+ . . . | \ No state change here |
| 0E0 \| | AK10 0015D | |
| 0E1 09 | 8V8S 04A12 @p+ a! @p+ . | |
| 0E2 | ALAK 00000 | |
| 0E3 | ALAK 00000 | |
| 0E4 | TSSS 2E9B2 push . . . | |
| 0E5 | 8DS4 058B4 @p+ !a+ . unext | |

| | | |
|---|---|---|
| 0E6 RM\| | HJT4 366BC 2* not push unext | \ Code only for 09 |
| 0E7 09* | 8U8S 04B12 @p+ b! @p+ . | |
| 0E8 \| | AKG0 001D5 | |
| 0E9 \| | AK10 0015D | |

| | | |
|---|---|---|
| 0EA 19 | 2LQK 10080 | \Third extra-root substream |
| 0EB | AK20 00145 | \ next two load code to root |
| 0EC | ALAC 00006 | \ last one is pinball pair |
| 0ED 29 | 3K20 12145 call 145 | \This is total “no content” branch (forced even) |
| 0EE | 8U8S 04B12 @p+ b! @p+ . | |
| 0EF | AK80 00115 | |
| 0F0 | ALAG 00001 | |
| 0F1 | T8S8 2FDB7 push @p+ . @p+ | |
| 0F2 39 | SSSS 2C9B2 . . . . | |
| 0F3 | 3K80 12115 call 115 | |
| 0F4 29 | EESS 09BB2 !b !b . . | |
| 0F5 | 8ES4 05BB4 @p+ !b . unext | |
| 0F6 39* | 8SSS 049B2 @p+ . . . | |
| 0F7 \| | AK10 0015D | |
| 0F8 29* | 8U8S 04B12 @p+ b! @p+ . | |
| 0F9 \| | AK80 00115 | |
| 0FA \| | AK10 0015D | |
| 0FB 19 | 2LQK 10080 | \ First two words of three word root load |
| 0FC | ALAG 00001 | |
| 0FD | ALAK 00000 | |
| 0FE RM\| | HJT4 366BC 2* not push unext | \ “content” |
| 0FF \| | KKKK 3C1F0 + + + + | |
| 100 19 | 2LQK 10080 | \ Last two words of three word root load |
| 101 | ALAS 00002 | |
| 102 | ALAK 00000 | |

| | | |
|---|---|---|
| 103 RM\| | KKKK 3C1F0 + + + + | \ “content |
| 104 \| | SSSS 2C9B2 . . . . | |

| | | |
|---|---|---|
| 105 19\| | QLAG 20001 | \The two word pinball (and the pc for root) |
| 106 | AKQ0 00185 | |
| 107 | ALAK 00000 | |

| | | |
|---|---|---|
| 108 PB | 8EU0 05BA5 @p+ !b b! ; | \ Sent to 09, 29, 18 |

| | | |
|---|---|---|
| 109 | EU0S 08B52 !b b! ; | \ then to 08, 39, 17,28 |
| [THEN] | | |

While specific examples of the inventive computer arrays 10, computers 12, paths 84 and associated apparatus, and stream loader method as illustrated in FIG. 1-5 and Examples 1-6 have been discussed herein, it is expected that there will be a great many applications for these which have not yet been envisioned. Indeed, it is one of the advantages of the present invention that the inventive method and apparatus may be adapted to a great variety of uses.

All of the above are only some of the examples of available embodiments of the present invention. Those skilled in the art will readily observe that numerous other modifications and alterations may be made without departing from the spirit and scope of the invention. Accordingly, the disclosure herein is not intended as limiting and the appended claims are to be interpreted as encompassing the entire scope of the invention.

### INDUSTRIAL APPLICABILITY

The inventive computer arrays 10, computers 12, stream loader 100 and stream loader method of FIG. 5 and Examples 1-6 are intended to be widely used in a great variety of computer applications. It is expected that it they will be particularly useful in applications where significant computing power is required, and yet power consumption and heat production are important considerations.

As discussed previously herein, the applicability of the present invention is such that the sharing of information and resources between the computers in an array is greatly enhanced, both in speed a versatility. Also, communications between a computer array and other devices is enhanced according to the described method and means.

Since the computer arrays 10, computers 12, stream loader 100 and stream loader method of FIG. 5 of the present invention may be readily produced and integrated with existing tasks, input/output devices, and the like, and since the advantages as described herein are provided, it is expected that they will be readily accepted in the industry. For these and other reasons, it is expected that the utility and industrial applicability of the invention will be both significant in scope and long-lasting in duration.

We claim:

1. In a group of computer processors and ports, an improvement comprising:
a loader for transmitting information selected from the group of data, locations and instructions through a port to a first processor; and
wherein said first processor is programmed to enter information intended for loading such first processor and transport such loader to a second processor.

2. The improvement of claim 1, wherein:
said second processor is programmed to enter information intended for such second processor and transport said loader to a third processor.

3. The improvement of claim 1, wherein:
said second processor is programmed to execute instructions from the input port without interaction with said first processor.

4. The improvement of claim 2, wherein:
said loader includes a location selected from the group of up, down, left and right to transport said transport means to said second processor.

5. The improvement of claim 2, wherein:
said information is a transfer of instructions from said port to said second processor.

6. The improvement of claim 2, wherein:
said information is a transfer of data from said port to said second processor.

7. The improvement of claim 2, wherein:
said information is in the form of data and/or instructions being sent from said port to said second processor.

8. The improvement of claim 1, wherein:
said input port is an external port for communicating with an external device.

9. The improvement of claim 1, wherein at least one of said processors includes:
an instruction register for temporarily storing a group of instructions to be executed; and
a program counter for storing an address from which a group of instructions is retrieved into said instruction register; and
wherein the address in said program counter can be either a memory address or the address of a port.

10. The improvement of claim 9, wherein:
said group of instructions is retrieved into said instruction register generally simultaneously; and
said plurality of instructions is repeated a quantity of iterations as indicated by a number on a stack.

11. The improvement of claim 1, wherein at least one of said processors includes:
a plurality of instructions that are read generally simultaneously; and
wherein said plurality of instructions is repeated a quantity of iterations as indicated by a number on a stack.

12. A method for transmitting data to computers in a multicomputer array with an input port having at least one computer not directly connected to said input port, comprising:
(a) introducing an input into said port causing a first computer connected to said input port to transmit a portion of said input to a second computer not connected to said input port;
(b) causing a second computer to enter a portion of said portion of said input.

13. The method of claim 12, wherein:
said second computer reacts to the portion of said portion of said input from said first computer by executing a task.

14. The method of claim 12, wherein:
in response to input from the port said second computer runs a routine.

15. The method of claim 14 wherein:
said routine includes interfacing with a third computer.

16. The method of claim 15, wherein:
said routine includes writing to said third computer.

17. The method of claim 15, wherein:
said routine includes sending data to said third computer.

18. The method of claim 15, wherein:
said routine includes sending instructions to said third computer.

19. The method of claim 18, wherein:
said instructions are executed by said third computer sequentially as they are received.

20. A computer readable medium having code embodied therein for causing an electronic device to perform the steps of claim 12.

21. A computer readable medium having code embodied therein for causing an electronic device to perform the steps of claim 13.

22. A computer readable medium having code embodied therein for causing an electronic device to perform the steps of claim 14.

23. A computer readable medium having code embodied therein for causing an electronic device to perform the steps of claim 15.

24. A computer readable medium having code embodied therein for causing an electronic device to perform the steps of claim 16.

25. A computer readable medium having code embodied therein for causing an electronic device to perform the steps of claim 17.

26. A computer readable medium having code embodied therein for causing an electronic device to perform the steps of claim 18.

27. A computer readable medium having code embodied therein for causing an electronic device to perform the steps of claim 19.

28. A system for computing comprising:
a group of processors including at least one input port attached to one of said processors; and
loader means for transmitting information selected from the group of data, instructions and locations from said one input port to one of said processors and to another of said processors,
wherein said loader means further includes a path determined by direction instructions and a means for instructing said another processor to load a payload.

29. A system for computing as in claim 28, wherein said loader means indicates the location of said one processor relative to said input port.

30. A system for computing as in claim 29, wherein said loader means indicates the location of said another processor relative to said one processor by including a direction selected from the group consisting of up, down, right and left.

31. A system for computing as in claim 29, wherein said loader means indicates the location of said another processor relative to said one processor by including a direction selected from the group consisting of north south east and west.

32. A system for computing as in claim 28, wherein said loader means indicates the location of said one processor absolutely by including the address of said one processor.

33. A system for computing as in claim 28, wherein said payload is data.

34. A system for computing as in claim 28, wherein said payload is instructions and said another processor executes said instructions.
